(19) United States
(12) Patent Application Publication
(10) Pub. No.: US 2008/0295543 A1
(43) Pub. Date: Dec. 4, 2008

(54) WASHING MACHINE APPARATUS AND METHOD

(76) Inventors: Justin Brubaker, Lafayette Hill, PA (US); Robert Keith Hollenbeck, Fort Wayne, IN (US); Bruce Calvin Ley, Ossian, IN (US)

Correspondence Address: General Electric Company;GE Global Patent Operation, PO Box 861, 2 Corporate Drive, Suite 648, Shelton, CT, 06484, US

(21) Appl. No.: 11/756,915

(22) Filed: Jun. 1, 2007

(51) Int. Cl. H02P 3/18; D06F 33/02; D06F 37/24

(52) U.S. Cl. 68/12.16; 318/764

(57) ABSTRACT

A washing machine is provided that includes an induction motor and a motor control circuit with a feedback loop. The feedback loop provides rotor speed to a microprocessor of the motor control circuit. The motor control circuit and feedback loop control the motor such that the motor operates in a reverse frequency mode which provides braking to the washing machine.

### BACKGROUND OF THE INVENTION

1. Field of the Invention

The present disclosure is related to washing machines. More particularly, the present disclosure is related to washing machine braking.

2. Description of Related Art

Vertical axis washing machines, also known as top loading washing machines, represent a large portion of the overall washing machine consumer market in the United States. Horizontal axis washing machines represent a smaller segment of the United State market and abroad typically represent a larger portion of the overall washing machine consumer market.

Most vertical axis washing machines include a spin cycle for removing water and/or detergents from the laundry using centrifugal force and spinning a wash load tub, also referred to as a laundry tub (“tub”) or basket. During a typical spin cycle, the motor, typically an induction motor, of the washing machine spins the tub at relatively high speed(s).

Historically induction motors used in washers have been single phase induction motors or PSC induction motors. More recently 3-phase induction motors, have been used in some commercially available washers. The 3-phase motors in washers for home use are typically powered by standard single phase AC household electric power. As part of a 3-phase induction motor washing machine, a circuit associated with the motor converts the single phase AC household electric power to three phase power; the three phase power is better at motor starting and operates more efficiently than single phase power.

A simplified explanation of an induction motor, ignoring losses follows: The induction motor has a rotor with a short-circuited winding inside a stator with a rotating magnetic field. The flux from the rotating field induces a current flow in the rotor. The frequency of the current flowing is equal to the difference between the rotational speed of the stator field and the rotational speed of the rotor. This difference in speed, or frequency, of the stator magnetic field and the rotor magnetic field is known as the slip.

The rotor current causes a rotor magnetic field, which is spinning relative to the rotor at the slip frequency and relative to the stator field, at the same slip frequency as. The interaction between rotor magnetic field and the stator magnetic field generates a torque in the rotor.

A wash load wash cycle has various modes such as fill, drain and spin, agitation, and spin. Braking can occur before, during or after various segments of the wash cycle. Braking can be dictated by wash cycle parameters and also by safety standards, such as UL safety standards. Typical intermittent wash load braking during the spin mode of the wash cycle is performed in accordance with UL safety standards. For example, if a lid, such as the lid of a vertical washing machine, is opened during the spin modes or cycle, the wash load brakes within a predetermined time limit, such as a 7 second stop-time that is a UL safety standard. Other safety standards and/or stop times may also be available for safety purposes during various modes of the wash cycle.

Some prior art washing machines or washers typically rely upon mechanical brakes such as brake pads or shoes to bring a rotating load, such as a washing machine tub, to zero speed or zero angular velocity in a clothes washer.

The use of brake pads or shoes to stop a washing machine tub is costly and also affects the life of the washing machine dependent upon use since each brake shoes or pad has a wear surface that is subject to wear and eventually, after a period of use, will fail due to wear. Hence there is a wide variation in life of a washer model configured with brake pads or shoes, depending upon subjective factors, i.e. the user or consumer's use of the washing machine including frequency of use and type of use. The type of use varies in the selection of cycle such as a gentle cycle or a heavy-duty cycle. The braking of spin associated with a gentle cycle likely causes less brake wear than the braking of spin associated with a heavy-duty cycle. There are also variations in braking dependent upon the load size or water level used. A large load may spin longer and at greater angular velocity than a small load; thus causing greater wear on the brake. A higher water level, using more water than a lower level, less full load, would also require additional spin for water removal and could cause greater wear on the brake.

Other prior art washing machines or washers use permanent magnet motors and control circuits to provide braking to the washer without using a brake pad or shoe applied to the washer tub to bring the rotating load to zero speed or zero angular velocity. Generally a permanent magnet motor operates like a generator when braking; typical excess electrical energy from the generator mode is either dissipated via a power brake resistor or sent out to the electrical system using, for example, the line synchronization technique.

Prior art washing machines that use a resistor or line synchronization to dissipate energy in braking can cause increased cost per unit in manufacturing. The use of a resistor in a control circuit, for example, impacts component sizing in the control circuit and cost of the control circuit.

Accordingly, there is a need for a washing machine that overcomes, alleviates, and/or mitigates one or more of the aforementioned and other deleterious effects of prior art washing machines.

### BRIEF SUMMARY OF THE INVENTION

A washing machine is provided that includes an induction motor and a motor control circuit with a feedback loop. The feedback loop provides rotor speed to a microprocessor of the motor control circuit. The motor control circuit and feedback loop control the motor such that the motor operates in a reverse frequency mode which provides braking to the washing machine.

An exemplary method of the present invention provides for washing machine braking. The method of braking the washing machine includes: a method of braking a washing machine with a motor, the method including: operating the motor in reverse frequency braking mode to slow the motor to a first slow speed; and operating the motor in a dc braking mode, when the motor is operating at a second slow speed, wherein the second slow speed is less than the first slow speed, and wherein in the dc braking mode the motor is slowed to a stop.

The above brief description sets forth rather broadly the more important features of the present invention in order that the detailed description thereof that follows may be better understood, and in order that the present contributions to the art may be better appreciated. There are, of course, additional features of the invention that will be described hereinafter and which will be for the subject matter of the claims appended hereto.

In this respect, before explaining several embodiments of the invention in detail, it is understood that the invention is not limited in its application to the details of the construction and to the arrangements of the components set forth in the following description or illustrated in the drawings. The invention is capable of other embodiments and of being practiced and carried out in various ways. Also, it is to be understood, that the phraseology and terminology employed herein are for the purpose of description and should not be regarded as limiting.

As such, those skilled in the art will appreciate that the conception, upon which disclosure is based, may readily be utilized as a basis for designing other structures, methods, and systems for carrying out the several purposes of the present invention. It is important, therefore, that the claims be regarded as including such equivalent constructions insofar as they do not depart from the spirit and scope of the present invention.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. Accordingly, the Abstract is neither intended to define the invention or the application, which only is measured by the claims, nor is it intended to be limiting as to the scope of the invention in any way.

Further, the purpose of the foregoing Paragraph Titles used in both the background and the detailed description is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. Accordingly, the Paragraph Titles are neither intended to define the invention or the application, which only is measured by the claims, nor are they it intended to be limiting as to the scope of the invention in any way.

The above-described and other features and advantages of the present disclosure will be appreciated and understood by those skilled in the art from the following detailed description, drawings, and appended claims.

### BRIEF DESCRIPTION OF THE SEVERAL VIEWS OF THE DRAWINGS

FIG. 1 is a sectional view of a washing machine according to an exemplary embodiment of the present invention;

FIG. 2 illustrates and exemplary exterior of a typical vertical axis washer, as well as some of the interior components;

FIG. 3 illustrates an exemplary control circuit of an embodiment of the present invention;

FIG. 4 illustrates a functional block diagram of an exemplary embodiment of braking of the present invention using reverse frequency mode;

FIG. 5 is an example of an open loop transfer function since for presentation purposes, FIG. 5 does not illustrate the feedback of embodiments of the present invention,

FIG. 6 is a cross-sectional view of an exemplary 3-phase induction motor comprising a rotor and a stator;

FIG. 7 illustrates an example of negative frequency braking mode that is part of an embodiment of the present invention, where the rotor is spinning in a counterclockwise direction illustrated by arrow ω, and the stator electric field is spinning in a clockwise direction illustrated by arrow S_{emf}; note that ωᵣ is in an opposite direction to S_{emf};

FIG. 8 illustrates an example braking profile of speed vs. time for an exemplary embodiment of the present invention.

### DETAILED DESCRIPTION OF THE INVENTION

### Washing Machine Introduction

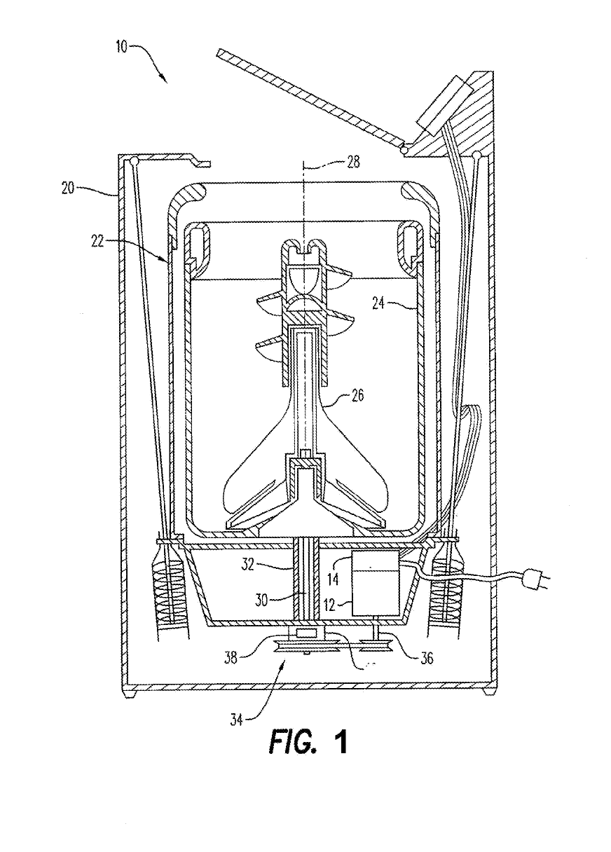

Referring to the drawings and in particular to FIG. 1, a washing machine (“washer”) according to an exemplary embodiment of the present invention is illustrated and is generally referred to by reference numeral 10. For purposes of clarity, only those aspects of washer 10 necessary for understanding of the present disclosure are described herein.

Washer 10 includes a motor 12and a motor control unit 14. Motor 12 is three-phase alternating current (AC) induction motor and, in some embodiments includes motor control unit 14 integral therewith. The motor control, integral therewith is referred to herein as integrated motor control (ICM) or control circuitry. Motor control unit 14 can include circuitry customized for an exemplary embodiment of the present invention.

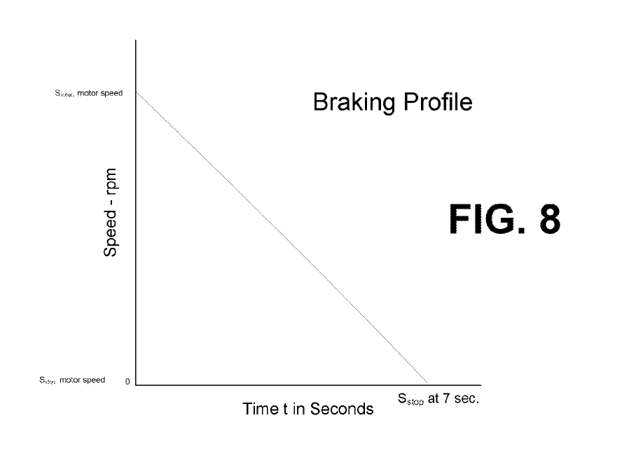

Washer 10 includes an outer housing 20 supporting a fixed tub 22, a basket or moving tub (“tub”) 24, an agitator 26, motor 12, and motor control unit 14 in a known manner. Agitator and basket drive shafts 30, 32 are also illustrated. Basket 24 is configured to hold articles (not shown) such as clothes to be washed. Circuit 14 is configured so that the receipt of a stop signal causes the circuit 14 to control the motor in a manner that brings the basket 24 to a stop. An example braking profile for an exemplary embodiment of the present invention is illustrated in FIG. 8. The braking profile or graph illustrates speed vs. time. At an initial speed, Sᵢₙᵢₜᵢₐₗ, braking begins and about 7 second later at a stop time Sₛₜₒₚ, the motor is stopped. In this example the speed of the motor 12 is adjusted over the course of the about 7 seconds using the rotor 13 speed feedback 52 to the microprocessor 61 and the microprocessor output 53 to the inverter 64 cause motor input voltage 57 adjustment, which thereby causes appropriate deceleration of motor 12. Appropriate braking profiles can be determined by one of ordinary skill in the art and used with embodiments of the present invention.

During a spin cycle, basket 24 and agitator 26 are configured to be driven by motor 12 to rotate at a high speed about vertical axis 28. In this manner, liquid within the articles is removed by the centrifugal force imparted by the spin cycle and is allowed to exit the basket through openings (not shown). During the spin cycle, basket 24 has an inertial load comprising the inertial load from the articles and inertial load inherent to the basket 24.

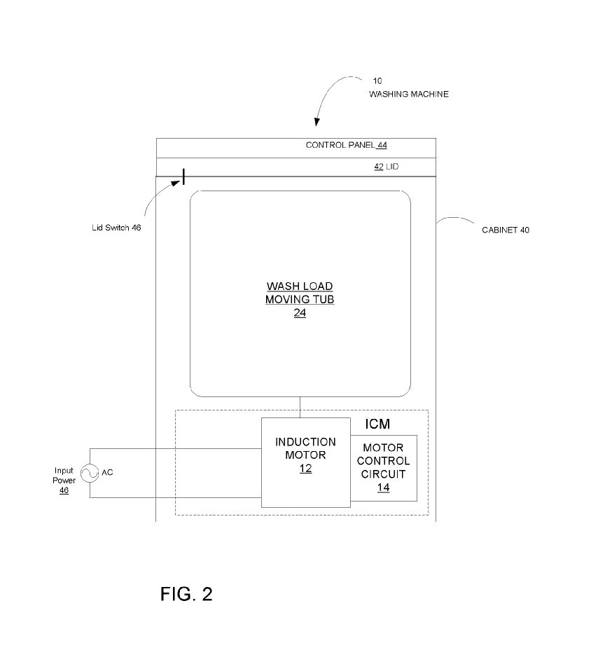

Another exemplary figure of a washer is illustrated in FIG. 2 which shows the exterior of a typical vertical axis washer, as well as some of the interior components. The washer 10 includes an exterior cabinet 40, a lid 42, a control panel 44, a lid switch 46. The washer 10 of FIG. 2 further includes a wash load tub 24 (moving tub), an induction motor 12 and an integrated motor control circuit 14, as well as a single phase AC power input 48.

With the advance of electronic components, electric control circuits can be configured to control the braking of the washer 10. As in an exemplary embodiment of the present invention, the lid 42 position can be monitored using a control circuit 14 comprises integrated motor control 14, or portion thereof, that monitors lid 42 position. The lid switch 46 can cause a state change in the monitoring circuit.

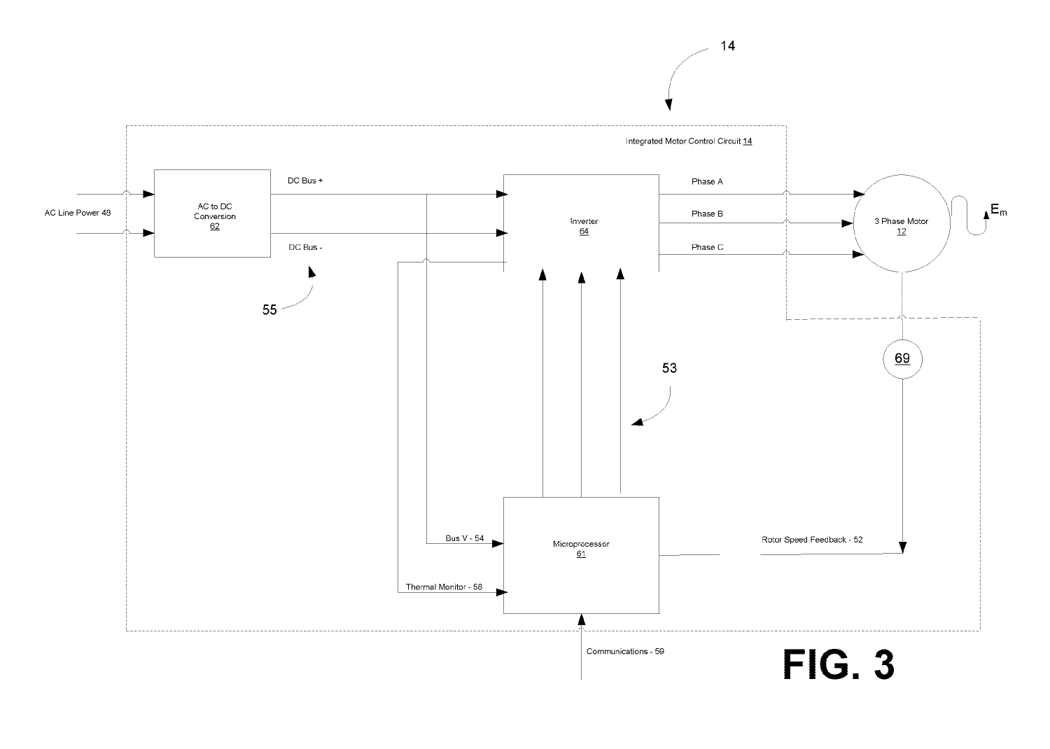

The exemplary electronic control circuits of the present invention include components such as a microprocessor 61 (see FIGS. 3) that can be programmed using a programming language such as C++ or assembly language. Alternately the microprocessor could be an application specific integrated circuit (ASIC). The type of microprocessor used in the control circuit could be determined by one of ordinary skill in the art.

Another component illustrated in the examples of the present invention is an AC to DC converter component 62 for converting single phase input power, such as conventional residential voltage of 110 v, 60 Hz in the US, to DC voltage. Additional components are also included in the control circuit, including an inverter 64 for converting single phase DC to three-phase AC power. Again, the choice of component can be determined by one of ordinary skill in the art. For example, the inverter could comprise an IGBT Bridge and Gate Drivers (not shown). The output of exemplary inverter 64 is 3-phase voltage labeled Phase A, Phase B and Phase C in FIGS. 3. The output voltage of the inverter 64 is input voltage 57 to the 3-phase induction motor 12 that is the exemplary motor for the embodiments of the invention described herein. Another output of the inverter is a thermal monitor signal 58.

The microprocessor 61 can be configured to handle a variety of inputs and provide a variety of outputs, also as determined by one of ordinary skill in the art. Example microprocessors of embodiments of the present invention illustrate inputs comprising DC bus voltage 54, communication(s) signals 59 and rotor speed feedback 52. The present invention is not limited to the inputs illustrated or the combinations of inputs illustrated. The microprocessor 61 further illustrates exemplary outputs 53 from the microprocessor to the inverter. These outputs provide driving signal 53 to the inverter 64 in order to for the inverter 64 provide various output voltages V and frequencies f supplied to the motor 12.

FIG. 3 illustrates an exemplary control circuit 14 of an embodiment of the present invention. The exemplary control circuit 14 of FIG. 3 further illustrates energy dissipation from the motor 12, Eₘ. The energy dissipation shown should not be interpreted as constant by its presence on the control circuit 14 illustration, rather, energy dissipation occurs appropriately during the operation of washer 12.; appropriate occurrence can be determined by one of ordinary skill in the art.

In an example of the present invention, the drive system Integrated Control 14 and Motor 12 (ICM) accomplishes braking of the washing machine load to zero speed after actuation of the lid switch during a spin cycle. This is different from the mechanical transmission in (that the induction motor electromagnetically stops the rotating load, as opposed to some mechanical braking surface; The methodology of the present induction motor differs from that of permanent magnet motors. During braking operation the motor produces a torque that slows the speed of the driven load. Various embodiments of methods and/or apparatus are available to provide braking energy, which is quantified in terms of change in system kinetic energy. Braking or deceleration torque is also delivered by various embodiments of methods and/or apparatus.

### Negative Frequency Braking and DC Braking Modes.

In an embodiment of the present invention, braking or deceleration of the washing machine tub 24 method utilizes a combination of braking modes, which are a function or the rotor speed. The braking modes performed in the present exemplary embodiment are a negative frequency braking mode and after the negative frequency braking mode a DC braking mode could be performed. [004

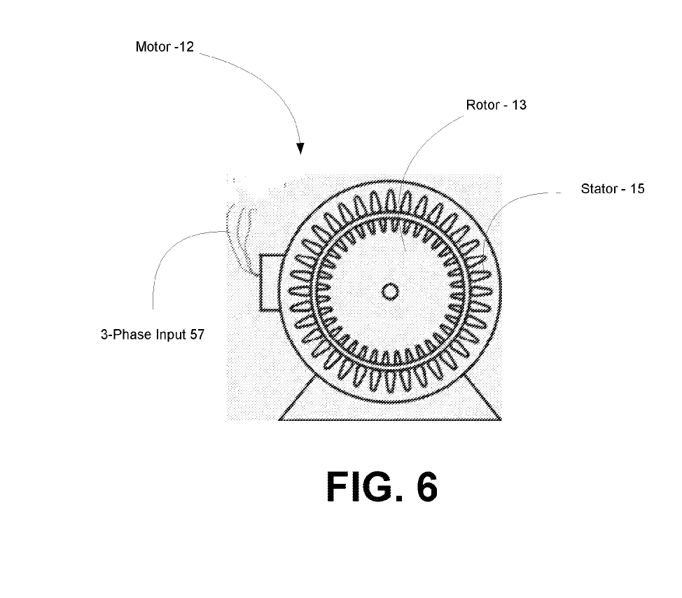

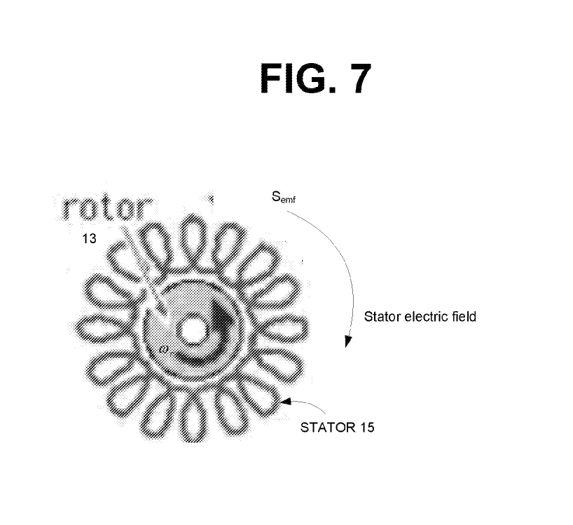

FIG. 6 is a cross-sectional view of an exemplary 3-phase induction motor 12 comprising a rotor 13 and a stator 15. Recall, from above, that with an induction motor 12, rotor 13 current causes a rotor 13 magnetic field, which is spinning relative to the rotor 13 at the rotor current frequency and relative to the stator field 15, at the same frequency. The interaction between rotor 13 magnetic field and the stator 15 magnetic field generates a torque in the rotor 13. A difference between the rotation direction of the input voltage 57 and the rotor 13 velocity is known as reverse frequency mode. The stator 15 field and the rotor 13 field cause an induced current flow in the rotor 13. In the negative frequency braking mode, where motor 12 speed is between for example, about 10,000 rpm and about 500 rpm, motor operation is at a negative electrical frequency. In the negative frequency braking mode the energy of the load is dissipated in the motor and no significant regeneration power is supplied back to the DC bus 55 of control circuit 14. In an exemplary negative frequency braking mode, illustrated in FIGS. 6 and 7, the rotor is spinning in a counterclockwise direction illustrated by arrow ωᵣ and the stator electric field is spinning in a clockwise direction illustrated by arrow S_{emf}; note that ωᵣ is in an opposite direction to S_{emf}.

In the DC braking mode, speed is between for example, about 500 rpm to about 0 rpm. In this DC braking mode, DC power is applied to winding of motor 12. This mode is optimal at low speeds or frequencies to bring the load of the motor load to a zero angular velocity or stop. Under the DC braking mode the energy of the load is dissipated in the motor and there is no significant regeneration power supplied back to the DC bus 55 of control circuit 14.

Utilizing the combination of braking methods mentioned above is advantageous, as substantially no power is regenerated to the control circuit 14, and therefore, additional circuits or components, such as e.g. braking resistor or line synchronization, for energy dissipation can be omitted.

### Braking Algorithm Transfer Functions

Parameters affecting stopping time include load inertia I and load torque T, as related in equation as follows:

T=Iα (4)

Maximum spin speed is specified and the required stop time is known; thus deceleration rate is known. Total mass moment of inertia is known through the specification of a load size and known tub 24 characteristics. A review of braking torque of embodiment(s) of the present invention reveals that addressing braking torque also addresses the handling of noise parameters, which are accounted for in some embodiments of the present invention. Noise parameters that affect motor braking torque of embodiments of the present invention include DC bus voltage level and induction motor temperature.

Voltage Compensation. In order to achieve voltage compensation, the input voltage 57 applied to the motor 12 should be sufficient in magnitude to provide drive current (not shown) for specified or given output torques (not shown). Motor input voltage 57 to the 3-phase induction motor is maintained using the control circuit 14. The motor voltage is provided initially from a DC bus 55, then through an inverter 64 where it is output as 3-phase AC voltage or motor input voltage 57. The AC motor input voltage 57 is maintained even under conditions where a voltage ripple might occur on the DC bus 55. Also, the motor input voltage 55 is maintained even if there is a voltage sag or voltage increase on an AC-line, such as the AC line power 48. In order to maintain a substantially constant input voltage 57 level to the motor 12, the integrated control 14 and associated circuit 14 provides for monitoring of the DC bus 55 voltage and adjusts output duty cycles. A definition of duty cycles provides that the duty cycles are time intervals devoted to device starting, running, stopping, and idling when a device, such as the motor 12, is used for intermittent duty.

The spinning basket 24, in configuration of a typical washing machine as described above and with an exemplary washing machine braking scheme of the present invention, the motor provides a substantially constant torque of a magnitude that can stop the inertia load within a predetermined time. Substantially constant torque can result from an application of a substantially constant voltage at a substantially constant negative frequency. However, the application of a substantially constant voltage does not account for a decrease in motor current that occurs as motor temperature increases and resistance increases.

The variation in motor torque output is accentuated in motor design that operates over a wide range of temperatures. In the present example the motor temperature can vary over a larger overall temperature range. For example, the motor 12 can be at room temperature if the washer 10 is in the mode referred to as drain-and-spin. In another example, the motor temperature can be much hotter, as compared to the temperature in the former example, if the motor 12 is running through multiple consecutive cycles or modes.

In order to ensure that motor torque output is sufficient, independent of motor temperature, where there is no closed loop feedback voltage is set sufficiently high in order to maintain the desired current or torque level. However, in this configuration the current applied to the motor when the motor is cool will be large. The result of this increased current is that electronic components must be of a larger size to maintain acceptable operating margins and therefore, this is a costly configuration.

It can be concluded from the above description that if some adjustment is made to the voltage setting of the AC motor 12, acceptable braking operation of the washing machine load, for example, can be provided. An embodiment of the present invention provides adjusted voltage, such that torque output is maintained. An alternate embodiment of the present invention also provides adjusted voltage, such that torque output is maintained.

Closed Loop Technique. The closed loop motor control circuit configuration uses available feedback including motor speed and bulk, or DC bus 55, voltage. The control circuit 14 adjusts output voltage 57 to the motor 12 to maintain a desired torque level. The torque is a turning effort or force acting through a radius of the motor 12 rotor 13. The exemplary closed loop motor control circuit configuration of the present invention is used to provide washing machine 10 load braking. An exemplary closed loop control circuit of the present invention are illustrated in FIG. 3.

In FIG. 3 the exemplary closed loop motor control circuit 14 of the present invention performs washer 10 load braking by adjusting inverter 64 output voltage 57 (also known as motor input voltage 57) to the motor 12 based upon a speed according to a desired deceleration profile of the load (AKA rotating load) in order to substantially maintain a stopping time such as a predetermined stopping time or a stopping time deemed acceptable under a given or assumed set of conditions. Example braking discussed herein is 7 seconds from spin cycle to stop. The braking profile of this braking action is ideally linear. A running speed of the washing machine is adjusted to decelerate to a stop in 7 seconds by adjusting the inverter output/motor input voltage 57. Changes are made to the voltage as determined by microprocessor 61, considering rotor speed feedback 52.

Closed Loop Factors/Definitions. In order to better understand stopping time based upon deceleration rate of a rotating load, such as a rotating washer tub 24, it is helpful to understand factors that effect deceleration rate. For the purposes of understanding the present explanation and the effect of the motor torque factors and mass moment of inertia of the rotating load, any inefficiency of the washer rotating tub 24 and/or the motor drive pulley 34 are neglected or ignored. Tub 24 and motor 12 drive pulley (not shown) inefficiencies are neglected because these inefficiencies are, for example, belt friction and/or bearing friction which slow the tub 24 and hence work to help the stopping.

Returning to the factors that effect deceleration rate, with respect to motor 12 torque, the factors that effect deceleration rate of the rotating load, specifically the example rotating washer tub 24 of the present invention, include: 1) motor torque T, where T=f(i), torque is a function of current, motor current i, where i=f(V, R), current is a function of voltage and resistance of the load. and motor resistance R, where R=f(temp), motor resistance is a function of temperature of the stator 15 windings of the motor 12; and 2) mass moment of inertia of rotating load 24.

Referring back to FIG. 3, generally, with respect to an exemplary closed loop motor control circuit 14 of the present invention, the following can be used to develop a method to decelerate a washing machine load: 1) Identify the substantially maximum speed at which tub 24 braking occurs; 2) Identify the a maximum load or articles, for example an about 32 lb dry load (or other representative load), that the closed loop motor control circuit 14 is able to brake to a stop; 3) Identify a maximum acceleration rate that can be used with the corresponding maximum load size, such as the exemplary about 32 lb dry load provided above, while substantially maintaining one or more predefined operating currents at acceptable levels and meet thee required stopping time of about 7 seconds; 4) Use the acceleration rate identified in 3) as an upper boundary and develop adaptive braking based upon the acceleration rate. Note that for the conditions described in 1)-3) above: i) substantially all loads will stop in approximately the same amount of time; ii) Current varies depending upon the load size. If load size is greater than the assumed maximum load size (AKA worst case) then the current will be over limit and may activate hardware (not shown) over-current trip; and 5) Implement an upper limit and a lower limit on voltage.

Note, with respect to 3) that: i) the washer 10 load is subjected to the UL safety standard where the load is specified to stop within the predetermined time set by the safety standards. An exemplary standard stop time of 7 seconds is a UL safety standard for instances where the lid 42 of the vertical washer 10 is opened during the spin mode or cycle; and ii) The washer 10 load stops within the predetermined time from a known maximum operating speed, such as, for example 750 rpm.

Torque Equations—Washer Tub Braking. The following equations are used to model braking of the washing machine tub 24:

$$\begin{matrix}T = I α = I \dot{ω} & ( 1 ) \\ \dot{ω} = \frac{T}{I} & ( 2 ) \\ ω = \frac{T}{I} t + {ω}_{0} , & ( 3 )\end{matrix}$$

Where ω₀ is the initial velocity upon the initiation of braking.

For ease of calculation, windage and friction are neglected. Therefore, at greater speed, the calculations will result in greater deviation from the actual operation for a given application or example.

Motor Equations—Reverse Frequency Braking Mode. The below equations are used to model reverse frequency braking of the washing machine tub 24. Note that reverse means that the frequency of the electrical signal applied to the voltage input 57 of motor 12 is reverse in direction to the spin direction of the washer tube 24 and motor shaft or rotor 13.

Motor Voltage, V=i*R (5)

relationship is independent of motor speed.

Motor Torque, T=K*i, (6)

Where K is equal to the torque per amp.

$$∴ T = \frac{K * V}{R} \qquad ( 7 )$$

Combined Equations—Reverse Frequency Braking Mode and Torque Equations. The following equations are used to model braking transfer functions of the washing machine tub 24:

$$\begin{matrix}\dot{ω} = \frac{K * V}{I * R} & ( 8 ) \\ ω = \frac{K * V}{I * R} t + {ω}_{0} & ( 9 )\end{matrix}$$

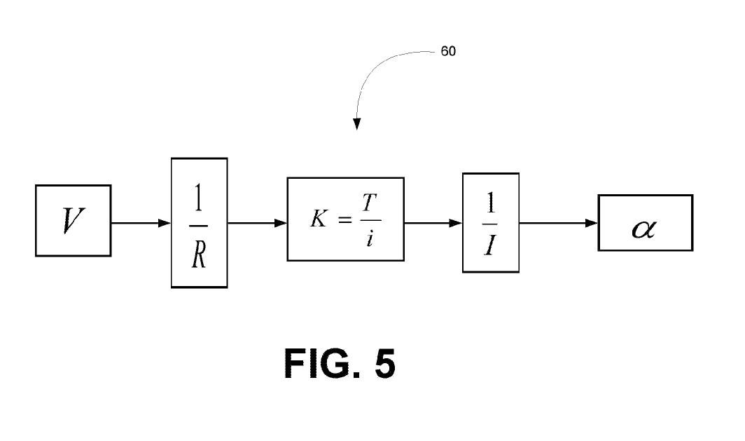

FIG. 5 is an example of an open loop transfer function 60 since for presentation purposes, FIG. 5 does not illustrate the feedback of embodiments of the present invention, In the open loop transfer function 60: V represents Input Voltage to motor; R represents Motor Resistance (Which varies according to motor temperature); K represents Torque per Amp Constant for Motor Operating in Reverse Frequency Mode; and I represents Mass Moment of Inertia of the Rotating Load (Which varies according to wash load size). The system diagram also includes I for motor 12 current and α for angular acceleration of the tub 24. An exemplary control scheme of the present invention corrects voltage input to the washing machine induction motor in order to maintain a required stop time, while ensuring that high currents do not result. The exemplary method of the present invention adjusts voltage to obtain angular velocity to substantially match a desired angular velocity for a given increment of time. The control loop is processing to substantially match velocity profile.

In the exemplary embodiment of the present invention, as follows, voltage is adjusted such that torque output is substantially maintained. Speed of the induction motor is measured at predetermined times or at predetermined intervals of time. An example time for measurement of induction motor speed is about 4 milliseconds. At about every 100 milliseconds a measured induction motor speed is compared to a desired induction motor speed for the predetermined time, which is a time, measured from the time of initiation of braking of the induction motor. The desired induction motor speed is calculated based upon a constant torque deceleration for a substantially worst-case load or a load that is considered less than optimal. The difference, which could also be called error, between measured induction motor 12 speed and desired induction motor 12 speed is calculated using the integrated control 14, using a feedback 52 portion provided to the Integrated Control 14 from the hall sensor 69. The feedback 52 of rotor speed to the processor 61 integrated control 14 is processed and output via microprocessor output 53 and provided to inverter 64 where it is applied to the voltage at the inverter 64, so that voltage is appropriately adjusted for output and hence motor input voltage thereby torque output of motor 12 is maintained.

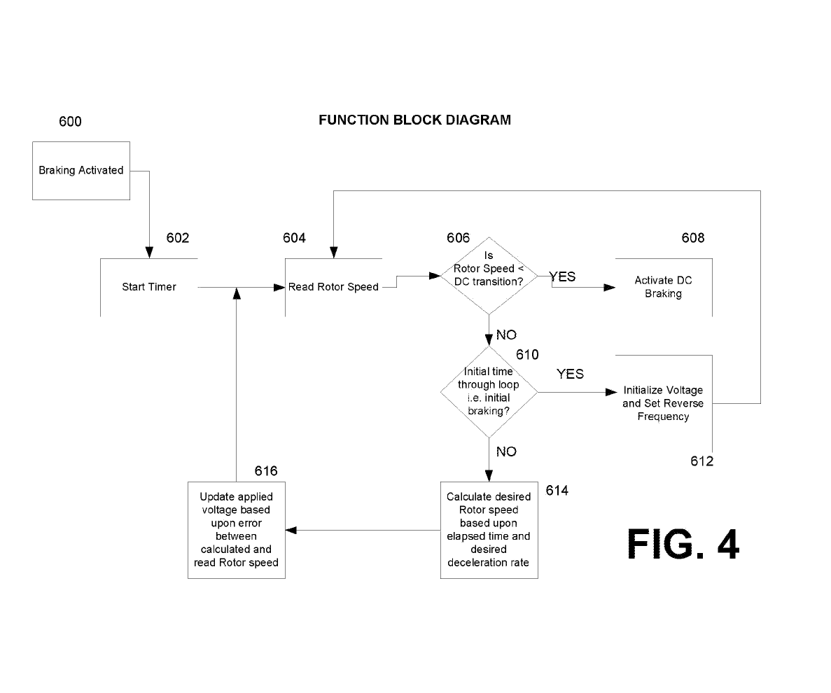

Returning to FIG. 4 which illustrates a functional block diagram of an exemplary embodiment of braking of the present invention using reverse frequency mode. At operator 600, braking is activated; then at operator 602 a speed and timing calculating timer begins at a start time. Next, at operator 604 speed of the rotor is read. At operator 606 a query is made as to whether the rotor speed is less than a DC transition in order to determine if the rotor is at or below critical rotor speed where the motor transfers from reverse frequency mode to dc mode. If the answer to the query of operator 606 is YES, then at operator 608 DC braking is activated. If the answer to the query of operator 606 is no, then another query is made at operator 610 as to whether this is the initial time, i.e. initial braking through loop is questioned. If the answer to the query of operator 610 is YES then voltage is initialized and reverse frequency of the motor is set at operator 612. After operator 612, there is a return to operator 604 where rotor speed is read. Operator 604 is followed by the operators previously described herein to follow operator 604. Returning to operator 610, if the answer to the query regarding initial time through the loop is NO then at the next operator, 614, desired speed of the rotor is calculated based upon elapsed time and desired deceleration rate. Operator 614 is followed by operator 616 where applied voltage based on error between calculated and read speed of the rotor is updated. Operator 616 returns to operator 604 where rotor speed is read again. Operator 604 is followed by the operators previously described herein to follow operator 604.

Below are example equations for obtaining voltage adjustment and an angular velocity as explained above and with the transfer function of FIG. 5 and functional block diagram of FIG. 4. The operands include initial voltage Vᵢₙᵢₜᵢₐₗ, the minimum voltage Vₘᵢₙ, the maximum voltage Vₘₐₓ and gain constant k Further operands of the equation are: S_{measured}, S_{calculated} for speed (measured and calculated); α for angular acceleration; and ω for angular velocity (initial). It should be noted that the minimum voltage level Vₘᵢₙ is chosen for the example in order to correct for inaccuracies in linear model encountered because windage and friction are not accounted for in the transfer function of FIG. 5. The following equations are represented with the operators explained herein:

$$\begin{matrix} {V}_{initial} = initial voltage setting & ( 10 ) \\ {V}_{min} = minimum voltage setting & ( 11 ) \\ {V}_{max} = maximum voltage setting & ( 12 ) \\ {α}_{Required} = desired deceleration rate & ( 13 ) \\ voltage update rule \text{:} \\ {V}_{n + 1} = {V}_{n} + k ( {S}_{Measured} - {S}_{Calculated} ) or {V}_{n} = {V}_{0} + {\sum }_{i = 1}^{n} {ke}_{n} & \begin{matrix} \\ ( 14 )\end{matrix} \\ {S}_{calculated} = {ω}_{0} - {α}_{Required} t & ( 15 ) \\ k = gain constant & ( 16 )\end{matrix}$$

In another exemplary embodiment of the present invention, motor 12 input voltage is adjusted such that motor 12 torque output is substantially maintained. The embodiment of the invention is carried out as follows: Speed of the induction motor 12 is measured at predetermined times i.e. t₀, t₁, t₂, or at predetermined intervals of time i.e. t₂−t₁ or t₁−t₀. At each interval of time an average deceleration rate is calculated using the motor control circuit 14. This average motor 12 deceleration rate is compared to a desired deceleration rate based upon a constant motor 12 torque deceleration of a substantially worst-case load or a load that is considered less than optimal. A percent error in motor 12 acceleration is multiplied by a previously applied voltage. Start with the percentage error from initial voltage at time n and use voltage from the previous time n=1. For example, for the first iteration n=0 note the use of an initial voltage value programmed in the control circuit 14. Next at iteration n=1 multiply percent error by voltage from time n=0. For a next iteration n=2 multiply the percent error at time n=2 by voltage at time n=1, etc. to account for change in induction motor 12 resistance. The percentage error is used so that voltage is appropriately adjusted since the percentage error is proportional to the adjustment in voltage that produces the desired torque output. The speed signal is used to provide feedback to the processor of the integrated motor control and appropriate adjustment is made to the voltage setting so that torque output is maintained.

Again we are provided with operators of initial voltage Vᵢₙᵢₜᵢₐₗ, minimum voltage Vₘᵢₙ, maximum voltage Vₘₐₓ and gain constant k. Other operators include t time, α average measured angular acceleration and required angular acceleration, both are raised to the increment n. The following equations are used to solve for angular acceleration when the initial voltage is known.

$$\begin{matrix}{V}_{initial} = initial voltage setting` & ( 17 ) \\ {V}_{n + 1} = {V}_{n} \frac{{α}_{D}}{\frac{( {S}_{initial} - {S}_{Measured} )}{t}} or {V}_{n} = {V}_{0} \frac{{α}_{D}^{n}}{{α}_{Average , {Measured}^{n}}} & ( 18 ) \\ {α}_{Required} = desired deceleration rate & ( 19 )\end{matrix}$$

In these exemplary embodiments of the present invention the motor is an induction motor and the invention dissipates energy through the use of metal that is part of the induction motor that provides for the specified operation of the motor. Thus, the induction motor, among its various elements, comprises metal. The metal is available for use in the dissipation of energy Additionally, this invention allows the most cost effective system design, as it dissipates energy in the motor to the greatest extent possible. Motors are designed or specified to motoring requirements such as a predetermined torque and speed for motoring output. These requirements are referred to herein as specified motoring requirements. The actual motoring requirements may be, for example 125% of the specified motoring requirements. The 25% requirements above specified requirements for the desired torque and speed is provided so that when the motor runs it does not run at its maximum torque and speed rating, which typically puts destructive stress on the motor. The motor 12 includes a quantity of material or metal, for example, copper for windings, for actual motoring requirements. Thus, for example, the motor 12 includes a quantity of copper for windings (i.e. stator windings 15) in order for the motor to obtain the torque and speed of the motoring requirements. Because of concerns for the motor 12, such as longevity, a typical motor may run at less than its specified torque and speed so that stress on the motor is less than it would be if the motor was designed to the lesser predetermined torque and speed. Since extra copper capacity, beyond the capacity needed for the predetermined output torque and speed, is available due to the actual motor requirements used in the design, there is an amount of free material, such as copper of this example, available for dissipation of braking energy. The above actual requirement of 125% is used as an example only and the actual motor requirements, the specified motoring requirements and the free material can be determined by one of ordinary skill in the art. Duty cycle for braking is much less than duty cycle when motor is running so that the motoring requirements upon which excess energy is put, are within acceptable ranges. Note that actual energy transferred due to excess energy is less than the energy transferred in motoring requirements.

This exemplary embodiment of the present invention accomplishes braking without the need for additional circuitry for energy dissipation i.e. braking resistor, line synchronization, etc. The reason is because power regeneration to the control circuit is substantially zero and therefore the need to dissipate energy is lowered or eliminated. It should be noted that the minimum voltage level Vₘᵢₙ is chosen for the example in order to correct for inaccuracies in linear model encountered because windage and friction are not accounted for in the transfer function of FIG. 5.

In addition to the accomplishment discussed above, this exemplary embodiment of the present invention accomplishes braking through the adjustment of output voltage from the control circuit or integrated motor control so that the tub speed reaches substantially zero speed within a predetermined time limit. The adjustment can also account for variation in motor performance over various operating temperatures.

In addition to the accomplishment discussed above, this exemplary embodiment of the present invention accomplishes braking through the use of a robust braking mechanism that meets specifications across a temperature range that is broader than the temperature range of some prior braking mechanisms. Cost is reduced because various, prior art components are not required. Additionally the motor may operate at higher temperatures than in prior art configurations, which allows for additional reduction in materials and thus, additional cost reduction.

In further embodiments of the present invention, washing machine braking could be influenced by different inputs, such as measured temperature, or measured current, for the purpose of adjusting output voltage to maintain motor performance.

The aforementioned embodiments of the present invention use an exemplary motor platform that is an AC induction motor. In an alternate embodiment of the present invention a different motor platform that is not an AC Induction motor may be used. One of ordinary skill in the art could determine an appropriate motor platform for the present invention. It should be noted that the control circuit 14 could be a circuit other than a circuit of a commercially available integrated motor and control.

The exemplary inventions discussed herein accomplish braking or washing machine braking by elimination of components such as, for example, braking resistors and associated circuitry and/or by the use of an adaptive circuit that provides for consistent operation of the washing machine over varying temperature.

It should also be noted that the terms “first”, “second”, “third”, “upper”, “lower”, and the like may be used herein to modify various elements. These modifiers do not imply a spatial, sequential, or hierarchical order to the modified elements unless specifically stated.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method of braking a washing machine with a motor, the method comprising:
a) operating the motor in reverse frequency braking mode to slow the motor to a first slow speed; and
b) operating the motor in a dc braking mode, when the motor is operating at a second slow speed, wherein the second slow speed is less than the first slow speed, and wherein in the dc braking mode the motor is slowed to a stop.

2. The method of claim 1 wherein the operating the motor in reverse frequency braking mode to slow the motor to a first slow speed comprises:
a) using a control circuit associated with the motor to calculate motor speed for braking;
b) comparing a desired speed based upon a desired deceleration rate and a speed from a rotor speed feedback circuit of the control circuit, to calculate a driving signal output from a microprocessor to an inverter; and
c) updating the voltage output signal of the inverter using the driving signal such that the motor operates in a reverse frequency mode and the reverse frequency mode causes the motor to decelerate to the first slow speed.

3. The method of claim 1 wherein the operating the motor in reverse frequency braking mode to slow the motor to a first slow speed comprises:
a) using a control circuit associated with the motor to calculate motor speed for braking;
b) calculating, with a microprocessor, an average deceleration rate based upon an initial speed provided by a rotor speed feedback circuit at initiation of braking and another speed provided by the rotor speed feedback circuit after a predetermined period of time;
c) comparing the average deceleration rate of b) to a predetermined deceleration rate to calculate a driving signal output from the microprocessor to an inverter; and
d) updating the voltage output signal of the inverter using the driving signal such that the motor operates in a reverse frequency mode and the reverse frequency mode causes the motor to decelerate.

4. A method of braking a washing machine, the method comprising:
a) providing a three phase induction motor, the three phase induction motor configured to receive an input voltage and provide output torque for spinning a tub of the washing machine;
b) providing a motor control circuit for the washing machine, the motor control circuit comprising a rotor speed feedback circuit, an inverter and a microprocessor, the microprocessor configured to receive the rotor speed feedback circuit;
c) processing with the microprocessor, the microprocessor configured to process signals received therein and cause the motor to spin the tub of the washing machine at a speed associated with torque provided by the input voltage and frequency signal to the motor;
d) identifying a braking signal, associated with an initiation of breaking, on the microprocessor control circuit;
e) calculating, with the microprocessor, a desired speed based upon a desired deceleration rate using time increment data associated with the initiation of breaking;
f) comparing the desired speed based upon a desired deceleration rate and a speed from the rotor speed feedback circuit, to calculate a driving signal output from the microprocessor to the inverter; and
g) updating the voltage output signal of the inverter using the driving signal such that the motor operates in a reverse frequency mode and the reverse frequency mode causes the motor to decelerate.

5. The method of claim 4 wherein in the reverse frequency mode the three phase induction motor converts mechanical energy into heat that dissipates in the rotor.

6. The method of claim 4 wherein when the rotor speed is less than a predetermined rotor speed, the motor operates in DC braking mode.

7. The method of claim 4 wherein the method continues until the tub is stopped.

8. The method of claim 6 wherein the method continues until the tub is stopped.

9. The method of claim 4 wherein when the rotor speed is in a predetermined range, the motor operates in reverse frequency mode.

10. The method of claim 4 wherein a driving signal is provided to the inverter based upon a delta calculation between a calculated rotor speed and a read rotor speed obtained from the control circuit, the calculated rotor speed is calculated by the microprocessor and the read rotor speed provided to the microprocessor from the rotor speed feedback circuit.

11. A method of braking a washing machine, the method comprising:
a) providing a induction motor, the induction motor configured to receive an input voltage and provide output torque for spinning a tub of the washing machine;
b) providing a motor control circuit for the washing machine, the motor control circuit comprising a rotor speed feedback circuit, an inverter and a microprocessor, the microprocessor configured to receive the rotor speed feedback circuit;;
c) processing with the microprocessor, the microprocessor configured to process signals received therein and cause the motor to spin the tub of the washing machine at a speed associated with torque provided by the input voltage and frequency signal to the motor;
d) identifying a braking signal, associated with an initiation of breaking, on the microprocessor control circuit;
e) calculating, with the microprocessor, an average deceleration rate based upon an initial speed provided by the rotor speed feedback circuit at initiation of braking and another speed provided by the rotor speed feedback circuit after a predetermined period of time;
f) comparing the average deceleration rate of e) to a predetermined deceleration rate to calculate a driving signal output from the microprocessor to the inverter; and
g) updating the voltage output signal of the inverter using the driving signal such that the motor operates in a reverse frequency mode and the reverse frequency mode causes the motor to decelerate.

12. The method of claim 11 wherein in the reverse frequency mode the induction motor converts mechanical energy into heat that dissipates in the rotor.

13. The method of claim 11 wherein when the rotor speed is less than a predetermined rotor speed, the motor operates in DC braking mode.

14. The method of claim 11 wherein the method continues until the tub is stopped.

15. The method of claim 13 wherein the method continues until the tub is stopped.

16. The method of claim 11 wherein when the rotor speed is in a predetermined range, the motor operates in reverse frequency mode.

17. The method of claim 11 wherein a driving signal is provided to the inverter based upon a delta calculation between a calculated rotor speed and a read rotor speed obtained from the control circuit, the calculated rotor speed is calculated by the microprocessor and the read rotor speed provided to the microprocessor from the rotor speed feedback circuit.

18. A washing machine comprising:
a motor comprising a motor input, a rotor and a stator;
a motor control circuit comprising a microprocessor, an inverter and a sensor device;
the microprocessor configured to receive rotor speed feedback from the sensor device and to provide output adjustment instructions to the inverter;
the inverter configured to the receive output adjustment instruction from the microprocessor and provide output voltage signal to the motor input and causes the motor to operate in reverse frequency braking mode;
wherein the inverter continues to provide output adjustment instructions as the control circuit receives the feedback from the sensor and the microprocessor provides output adjustment instruction to the inverter; and
wherein each output voltage signal to the motor, includes changes in voltage and frequency, and causes the motor to continue to operate in reverse frequency braking mode, where the motor is spinning in a direction opposite of the stator magnetic field; and
wherein by running the motor control circuit with the rotor speed feedback the motor decelerates to a stop.
